(19) United States
(12) Patent Application Publication
(10) Pub. No.: US 2011/0226872 A1
(43) Pub. Date: Sep. 22, 2011

(54) KIOSK

(75) Inventors: Arnold John Foppe, JR., St. Louis, MO (US); Kevin Edward Sprouse, Wildwood, MO (US); Gregory Paul Stout, Stow, OH (US)

(73) Assignee: Foot Traffic Media Group, LLC, St. Louis, MO (US)

(21) Appl. No.: 12/726,775

(22) Filed: Mar. 18, 2010

(51) Int. Cl. B05B 1/26; E03B 5/00; B05B 15/00

(52) U.S. Cl. 239/289; 137/565.17; 239/543; 137/560

(57) ABSTRACT

This invention presents a kiosk with novel kiosk housing. The kiosk housing has inner walls, outer walls, and an air circulation path between the inner walls and outer walls. The inner walls define an interior space. The kiosk further has a blower for supplying air into the air circulation path so as to fill the air circulation path with pressurized air. The kiosk can have a misting feature, visual and audio display, and scent feature.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

The present invention relates generally to kiosks, and more particularly to a kiosk with air circulation path.

2. Description of Related Art

Various technologies have been integrated into kiosks for providing pleasant visual effect. The present invention provides a kiosk with an improved kiosk housing structure.

### SUMMARY OF THE INVENTION

The present invention is a kiosk. The kiosk has a novel kiosk housing having inner walls, outer walls, and an air circulation path between the inner walls and outer walls. The inner walls define an interior space. The kiosk further has a blower for supplying air into the air circulation path so as to fill the air circulation path with pressurized air.

In a preferred embodiment of the present invention, the kiosk can further have a mist nozzle unit having a water injection nozzle and an air hole. The air hole is disposed adjacent the water injection nozzle. The kiosk further includes a water chamber for storing water therein, and a water pump for pumping water from the water chamber to the water injection nozzle.

In a preferred embodiment of the present invention, the water injection nozzle and the air hole can be disposed in the kiosk housing. A water conduit is connected between the water pump and the water injection nozzle. The air hole communicates with the air circulation path such that the pressurized air can exit the air circulation path via the air hole.

In a preferred embodiment of the present invention, the kiosk can further have a light device disposed within the interior space. Additionally or alternatively, a light device can be disposed within the air circulation path.

In a preferred embodiment of the present invention, the kiosk can further have a visual display. The visual display can be an LCD display. The LCD display can be pivotally or non-pivotally mounted on to the kiosk housing. Additionally or alternatively, the visual display is a transparent panel for removably holding a translucent display panel. The transparent panel can also be pivotally or non-pivotally mounted on to the kiosk housing.

In a preferred embodiment of the present invention, the kiosk can further have a side panel removably mounted onto the kiosk housing. Preferably, the side panel is translucent. The side panel can be a box module having an opening for collecting articles, such as cards or money, or dispensing articles, such as sample products or candy.

In a preferred embodiment of the present invention, the kiosk can further have a light device. Preferably, the kiosk housing can be translucent and the light device illuminates the kiosk housing for better aesthetic effect.

In a preferred embodiment of the present invention, the kiosk can further have an audio system having speakers.

In a preferred embodiment of the present invention, the kiosk can further have a scent medium retainer located adjacent to the blower so as to provide vaporized scent into the ambient air.

In a preferred embodiment of the present invention, the kiosk can further have a control board for serving as a user interface. The control board can have a switch module for allowing a user to selectively turn on and off any of the blower, the water pump, the light device, the LCD display, computer, and the audio system amplifier. The control board can also have a connection terminal for receiving an output jack of a video/audio device such as iPod. The control board can also have a device holder for removably retaining the video/audio device. The control board can also have an AC power outlet.

In a preferred embodiment of the present invention, the kiosk can further have a vertical tube extending vertically through the kiosk housing for receiving electric power lines. The kiosk can also have a tank base, and casters mounted onto the tank base.

In a preferred embodiment of the present invention, the kiosk can additionally or alternatively have a separate misting unit mounted on the kiosk housing. The misting unit has a water injection nozzle. A water conduit is connected between the water pump and the water injection nozzle. The misting unit has an opening, and a fan for blowing out air through the opening, and the water nozzle is disposed within the opening.

In a preferred embodiment of the present invention, the kiosk can further have a heater device mounted on the kiosk housing. Additionally or alternatively, the kiosk can have a camera device mounted on the kiosk housing. Additionally or alternatively, the kiosk can further have a street sign mounted on the kiosk housing. Additionally or alternatively, the kiosk can further have a pole mounted on the kiosk housing for supporting an article such as a tent or banner.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The above and other objects and features of the present invention will become apparent from the following description of preferred embodiments given in conjunction with the accompanying drawings, in which:

FIG. 1 is a front perspective view of a kiosk according to an embodiment of the present invention.

FIG. 2 is a rear perspective view of the kiosk of FIG. 1.

FIG. 3 is a front perspective view of the kiosk of FIG. 1 wherein the LCD display unit and the rear panel are omitted for the illustration purpose.

FIG. 4 is a front perspective view of the lower portion of the kiosk of FIG. 1 wherein the tank base is further omitted for the illustration purpose.

FIG. 5 is a cross-sectional view of the kiosk of FIG. 1 taken along line 5-5 in FIG. 1.

FIG. 6 is a partial, enlarged view of the kiosk of FIG. 1.

FIG. 7 is a perspective view of a variation of the side panel of the kiosk of FIG. 1.

FIG. 8 is a perspective view of another variation of the side panel of the kiosk of FIG. 1.

FIG. 9 is a front view of a variation of the kiosk of FIG. 1.

FIG. 10 shows a control board of the kiosk of FIG. 1.

FIG. 11 shows the kiosk of FIG. 1 with the LCD display or display panel is opened.

FIG. 12 is a perspective view of the kiosk of FIG. 1 with a heater device mounted thereon.

FIG. 13 is a perspective view of the kiosk of FIG. 1 with street signs mounted thereon.

FIG. 14 shows additional applications of the kiosk of FIG. 1.

### DETAILED DESCRIPTION OF THE INVENTION

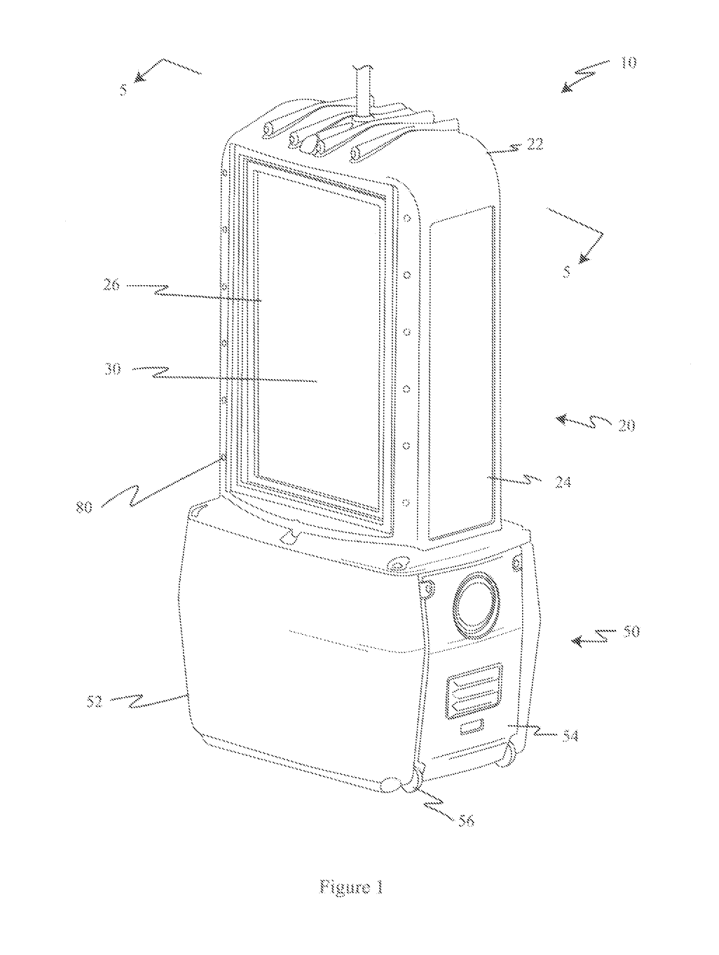

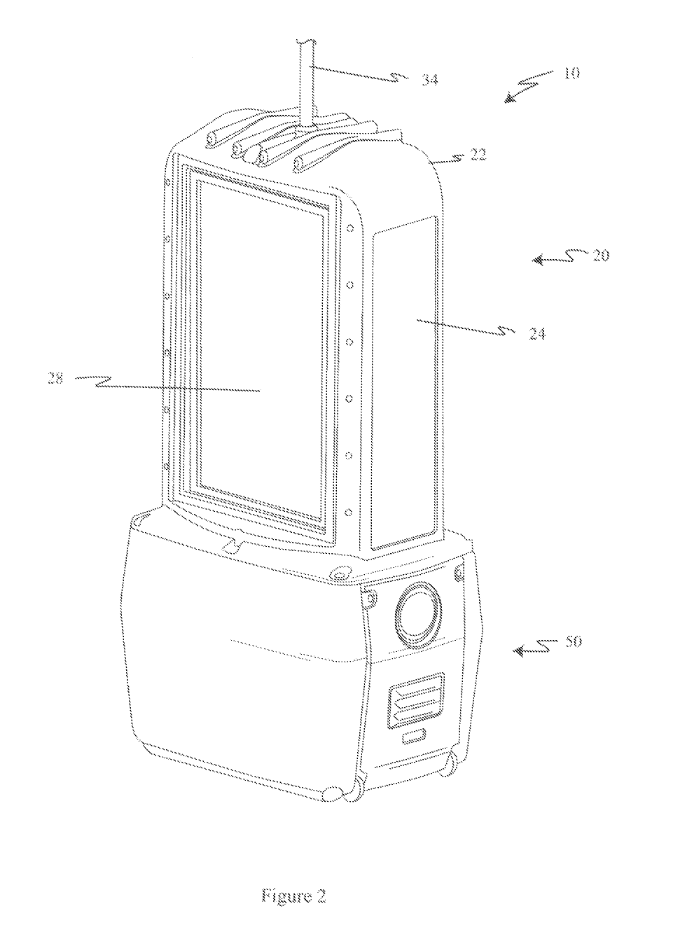

Shown in FIGS. 1 and 2 is a kiosk 10 according to one embodiment of the present invention. The kiosk 10 has an upper portion 20 and a lower portion 50. The upper portion 20 includes a kiosk housing 22, two upper side panels 24, an LCD display unit 30 disposed in the front face of the upper portion 20 (FIG. 1), and a rear panel 28 disposed in the rear face of the upper portion 20 (FIG. 2). The LCD display unit 30 can have a clear panel 26 covering and protecting the LCD panel. The lower portion 50 includes a tank base 52 and two lower side panels 54. Four service casters 56 are mounted on to the bottom of the tank base 52 so that the kiosk 10 can be easily moved.

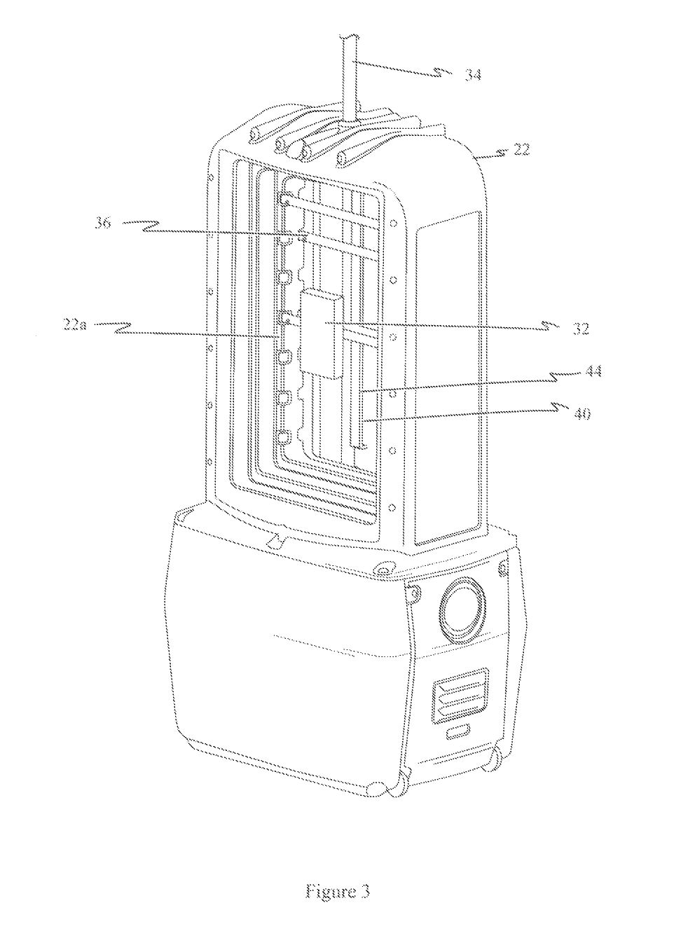

FIG. 3 shows a front perspective view of the kiosk 10 wherein the LCD display unit 30 and the rear panel 28 are omitted so that the interior of the upper portion 20 of the kiosk 10 can be illustrated.

As seen in FIG. 3, a vertical tube 34 extends vertically through the center of the upper portion 20 of the kiosk 10. The vertical tube 34 can serve as a conduit for receiving, for example, electric power lines and/or water lines. When other electric devices, such as surveillance cameras, are mounted on top of the kiosk housing 22 of the kiosk 10, the electric power lines can supply electric power to such electric devices. The kiosk housing 22 has inner walls 22a, which define an interior space. Four horizontal mounting rods 36 are shown to be mounted between the inner walls 22a of the kiosk housing 22 across the interior space. The horizontal mounting rods 36 can serve to mount other devices thereon. In the embodiment shown in FIG. 3, an IP interface module 32 and a light assembly 40 are mounted on to the horizontal mounting rods 36. The light assembly 40 is shown to extend vertically. However, the mounting rods 36 and the light assembly 40 can be arranged in a different orientation. The light assembly 40 can include fluorescent tubes 44. In an alternative embodiment, the light assembly 40 can be mounted directly onto the interior wall 22a, in which case the mounting rods 36 can be eliminated.

The kiosk housing 22 can be designed such that a display panel (not shown) can be removably held inside of the kiosk housing 22 adjacent to the rear panel 28. The display panel can be, for example, an advertisement display panel. The rear panel 28 is preferably transparent so that the display panel, when held inside of the kiosk housing 22, can be observed from outside of the kiosk 10 through the rear panel 28. The display panel can be made of translucent material so that it can be illuminated by the light assembly 40 or other illuminating devices disposed inside of the kiosk housing 22 for visibility and/or aesthetical purposes. The kiosk housing 22 can also be made of translucent material so as to provide illuminative and aesthetic effect.

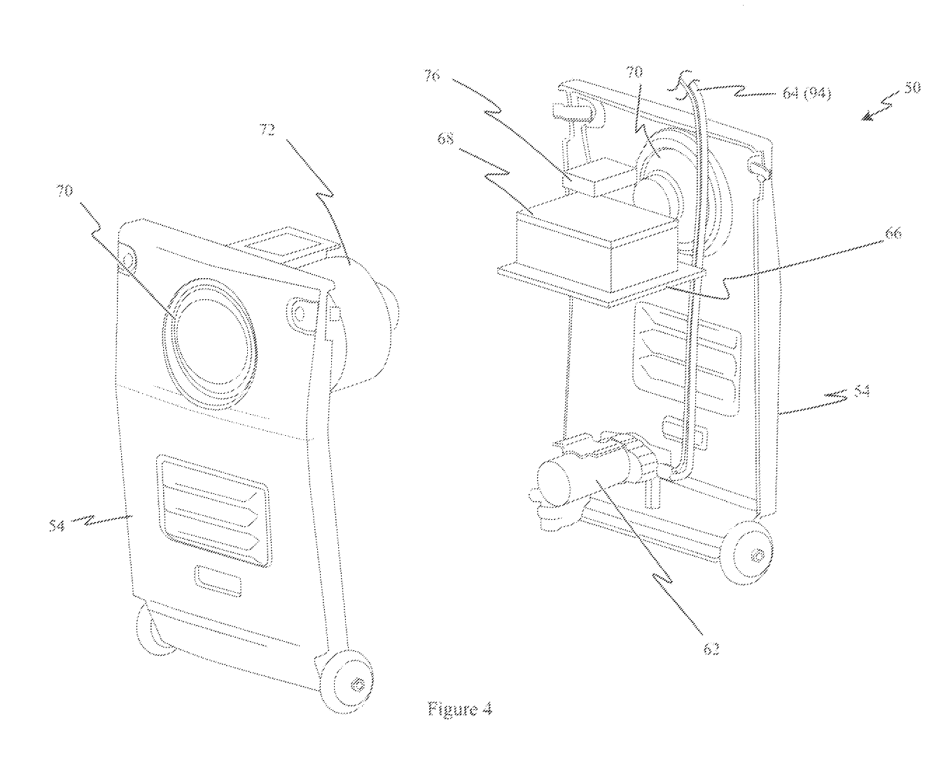

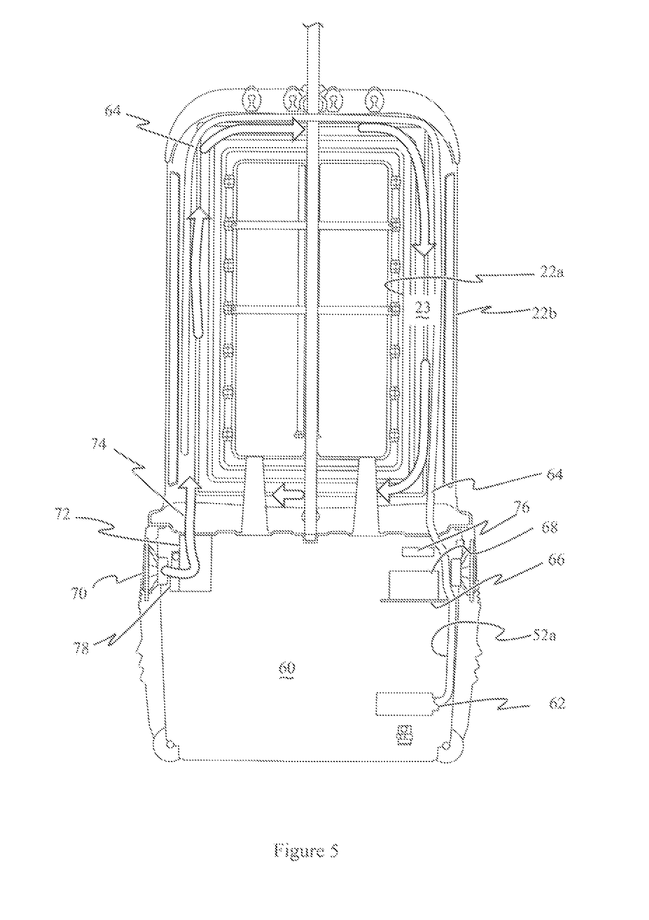

FIG. 4 shows a front perspective view of the lower portion 50 of the kiosk 10 wherein the tank base 52 is omitted so that the interior of the lower portion 50 of the kiosk 10 can be better illustrated. FIG. 5 shows a cross-sectional view of the kiosk 10.

As shown in FIGS. 4 and 5, a blower 72 is mounted within the lower portion 50 of the kiosk 10. As shown in FIG. 5, the kiosk housing 22 is hollowed between the inner walls 22a and outer walls 22b so as to have an air circulation path 23 therebetween. As shown, when the blower 72 blows air from outside into the air circulation path 23 via an air hole 74, the pressurized air circulates in the air circulation path 23. This way, while the blower 72 is operated, the air circulation path 23 is filled with a pressurized air. In the embodiments shown in FIGS. 3 and 5, the light assembly 40 is disposed within the interior space defined by the inner walls 22a of the kiosk housing 22. Additionally or alternatively, the light assembly 40 can be disposed within the air circulation path 23.

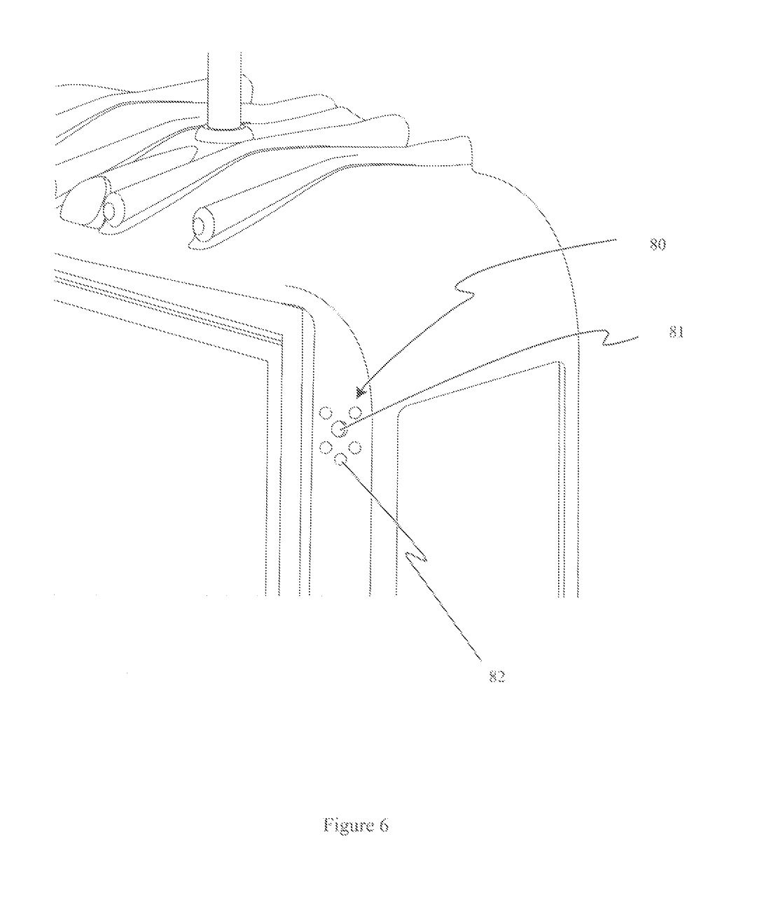

In the embodiments shown in FIGS. 1, 2 and 3, the kiosk housing 22 has mist nozzles 80 disposed in its front and rear faces. FIG. 6 shows an enlarged view of the misting nozzle 80. The misting nozzle 80 has a water injection nozzle 81 surrounded by adjacent air holes 82. The air holes 82 communicate with the air circulation path 23 of the kiosk housing 22 so that the pressurized air can exit the air circulation path 23 through the air holes 82.

As also shown in FIG. 5, an inner wall 52a of the tank base 52 defines a water chamber 60 for receiving water therein. As shown in FIGS. 4 and 5, a water pump 62 is disposed within the lower portion 50 of the kiosk 10. When operated, the water pump 62 pumps water out of the water chamber 60, feeding the pressurized water to the water injection nozzles 81 of the misting nozzles 80 via a water line 64. The water line 64 is connected to and communicates with the water injection nozzles 81 so that the pressurized water can be injected through the water injection nozzles 81. Accordingly, when the bower 72 and the water pump 62 are both operated, the pressurized air circulates within the air circulation path 23 and exits through the air holes 82 and the pressurized water flows through the water line 64 and is injected through the water injection nozzles 81. The exiting pressurized air and water are mixed together so as to form mist.

The kiosk 10 can also have a scent medium retainer or mount 78 next to the blower 72. The scent medium retainer 78 can retain scent medium in the form of liquid or solid. Accordingly, when the blower 72 blows air into the air circulation path 23, the scent medium can be vaporized or sublimated and caught by the flowing air so that the pressurized air exiting the kiosk 10 through the air holes 81 can carry scent. Preferably, the scent medium retainer 78 is located upstream of the blower 72.

As shown in FIGS. 4 and 5, a mount plate 66 is disposed within the lower portion 50 of the kiosk 10. A panel box 68 is mounted on the mount plate 66. Also shown are two speakers 70, respectively installed in the two lower side panels 54. The panel box 68 controls the speakers 70. The panel box 68 can have a memory medium for storing music or other audio data in the form of, for example, mp3 files or other electronic audio files. Such audio data can comprise audio advertisement or other information.

Also shown is an Internet Protocol (IP) controller 76. The IP controller 76 controls the LCD display unit 30 via the IP interface module 32. The IP controller 76 may transmit any kind of visual information such as visual advertisement, including but not limited to changing graphical display or animation, on the LCD display unit 30. The IP controller 76 can also control the light assembly 40 as well. In some embodiments, the IP controller 76 and the panel box 68 can be incorporated into a single unit.

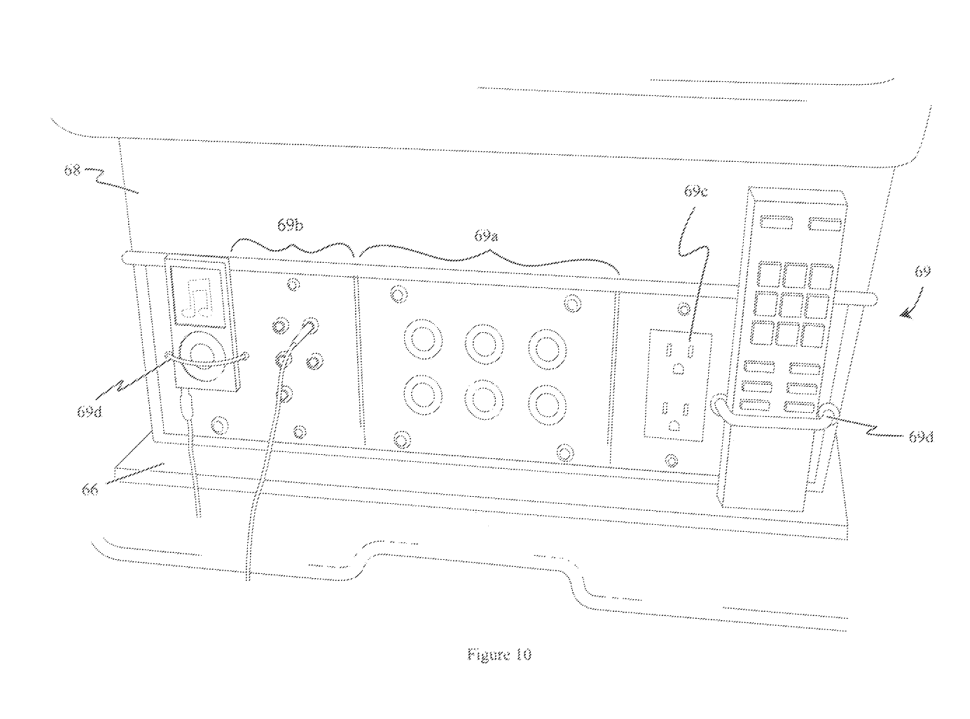

The panel box 68 can have a control board 29 as shown in FIG. 10. An operator can access the control board 29 by removing the lower side panel 54. The control board 29 has a switch module 69a, which can include multiple switches for selectively and independently turning on/off the blower 72, the water pump 62, the LCD display unit 30, the light assembly 40, the speakers 70 and the IP controller 76. The control board 29 also has a connector module 69b, which can have multiple connection terminals for receiving output jacks of outer audio/video devices, such as iPod devices. The control interface 29 can also have AC power outlets 69c for supplying electric power to other devices. The control interface 29 can also have elastic bands 69d for removably holding other devices, such as an iPod device or a remote controller, as shown.

In the embodiments shown in FIGS. 1, 2 and 3, the upper side panels 24 also carry a visual display text of “FOOT TRAFFIC MEDIA.” The upper side panels 24 can carry any other visual information such as visual advertisement, whether in a text form or not. The upper side panels 24 are preferably made of translucent material so that it can be illuminated by the light assembly 40 or other illuminating devices disposed inside of the kiosk housing 22 for visibility and/or aesthetical purposes. Preferably, the side panels 24 are removably mounted onto the kiosk housing 22.

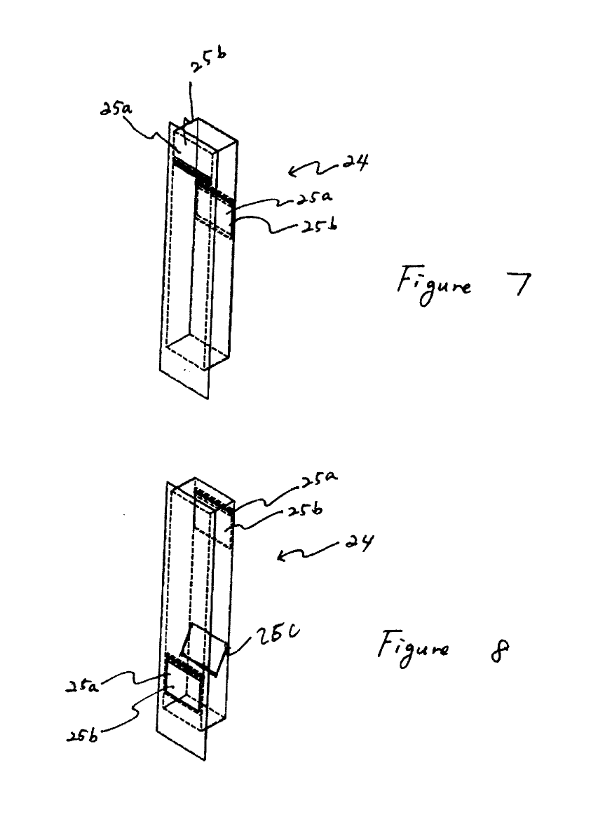

Additionally or alternatively, the upper side panels 24 can be designed in the form of box module as shown in FIGS. 7 and 8. In FIG. 7, the upper side panel 24 has openings 25a such that it can serve as a receptacle for collecting articles, such as cards and/or money. The openings 25a can have lids 25b for covering the openings 25a. In FIG. 8, the upper side panel 24 has openings 25a such that it can serve as a dispenser for dispensing articles, e.g. sample products, candy, brochures, entry forms, etc. The openings 25a can have hinged lids 25b for covering the openings 25a. An angled divider plate 25c is provided above hinged lid 25b. Angled divider plate 25c prevents too many dispensing articles from occupying and preventing the free movement of the swing area of hinged lid 25b. Preferably, angled divider plate 25c is fixed and non-moving and serves to maintain product clearance away from the pivoting travel area of hinged lid 26b.

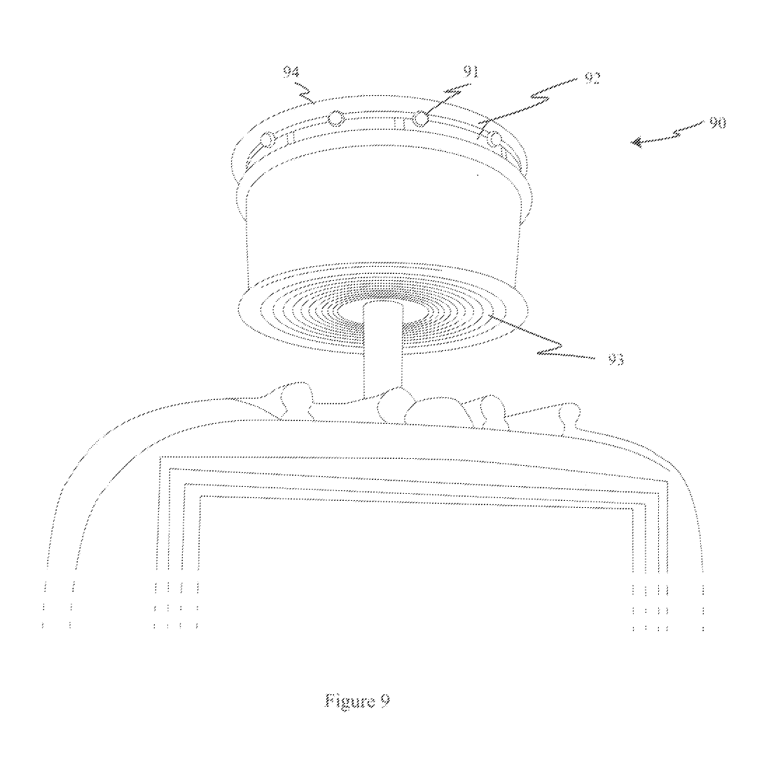

In the embodiments shown in FIGS. 1, 2, 3 and 6, the kiosk housing 22 has mist nozzles 80 disposed in its front and rear faces. Additionally or alternatively, the kiosk 10 can have a top misting unit 90 mounted on top of the kiosk housing 22, as shown in FIG. 9. The top misting unit 90 has a fan 93 for blowing air toward outside through a circumferential opening 92. Within and along the opening 92 are circumferentially arranged water injection nozzles 91. The water injection nozzles 91 are connected to and communicate with a water line 94. When operated, the water pump 62 pumps water from the water chamber 60, feeding the pressurized water to the water injection nozzles 91 via the water line 94. When the fan 93 and the water pump 62 are both operated, the pressurized air flows to outside through the opening 92 and the pressurized water flows through the water line 94 and is injected through the water injection nozzles 91. The exiting pressurized air and water are mixed together so as to form mist.

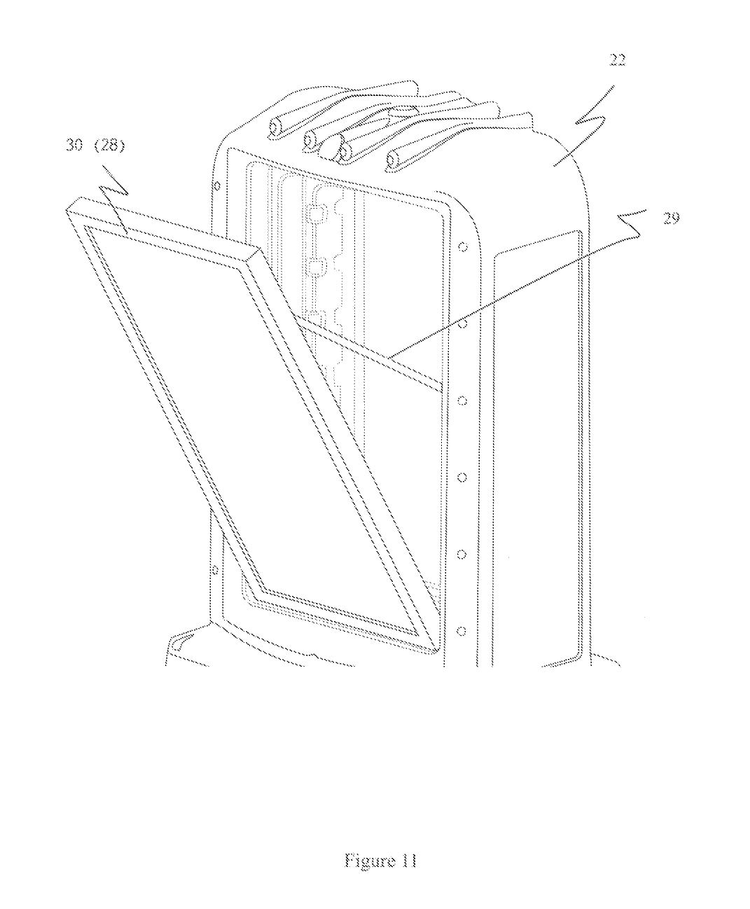

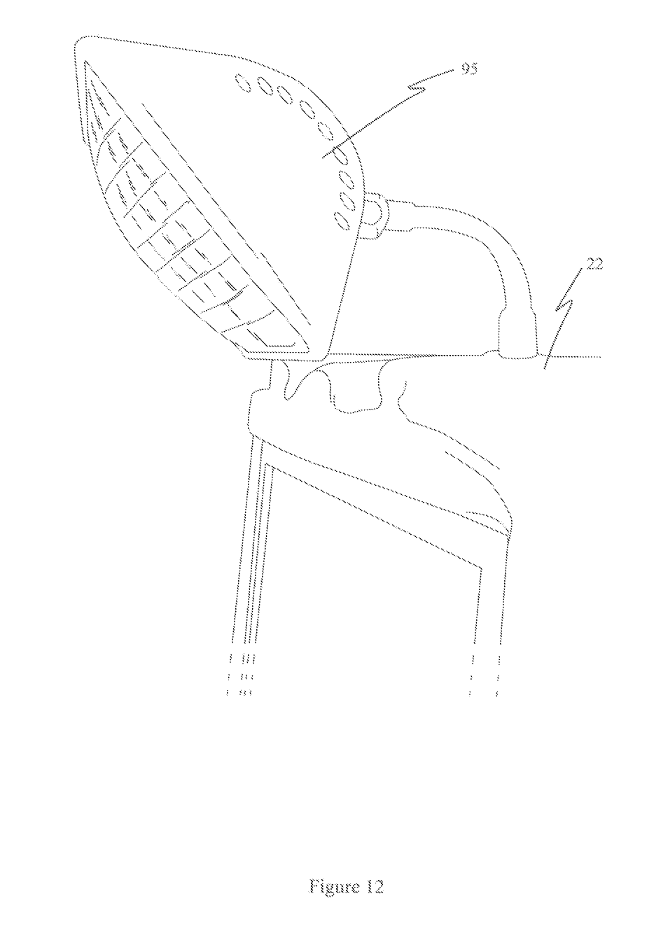

The LCD display unit 30 may be embodied as a pivotable unit as shown in FIG. 11. Specifically, pivot arm 29 is pivotally connected at one end to LCD display unit 20 and pivotally connected at the other end to the interior of kiosk 10. As seen in FIG. 11, pivot arm 29 preferably comprises a pneumatic telescoping arm that extends as LCD display unit 30 pivots away from kiosk 10. When the LCD display unit 30 is opened, the interior space of the kiosk 10 is accessible for maintenance. Additionally or alternatively, the rear panel 28 can be embodied as a pivotable unit.

In the illustrated embodiments, the kiosk 10 has an LCD display unit 30 disposed in the front face and a rear panel 28 disposed in the rear face. However, in other embodiments, the rear panel 28 can be replaced with another LCD display unit 30. Alternatively, the LCD display unit 30 disposed in the front face can be replaced with a front panel similar to the rear panel 28.

The kiosk 10 according to the present invention may be provided with a heater device 95 mounted on top of the kiosk housing 22 as shown in FIG. 12. The vertical tube 34 extending vertically through the upper portion 20 of the kiosk 10 can serve as a conduit for receiving electric power lines to provide electrical power to the heater device 95. Additionally or alternatively, the kiosk 10 may also have a camera, such as a security camera, mounted on top of or inside the kiosk 10. In other words, a security cameras may be attached to the kiosk 10. The camera is preferably provided with a security alarm to prevent tampering.

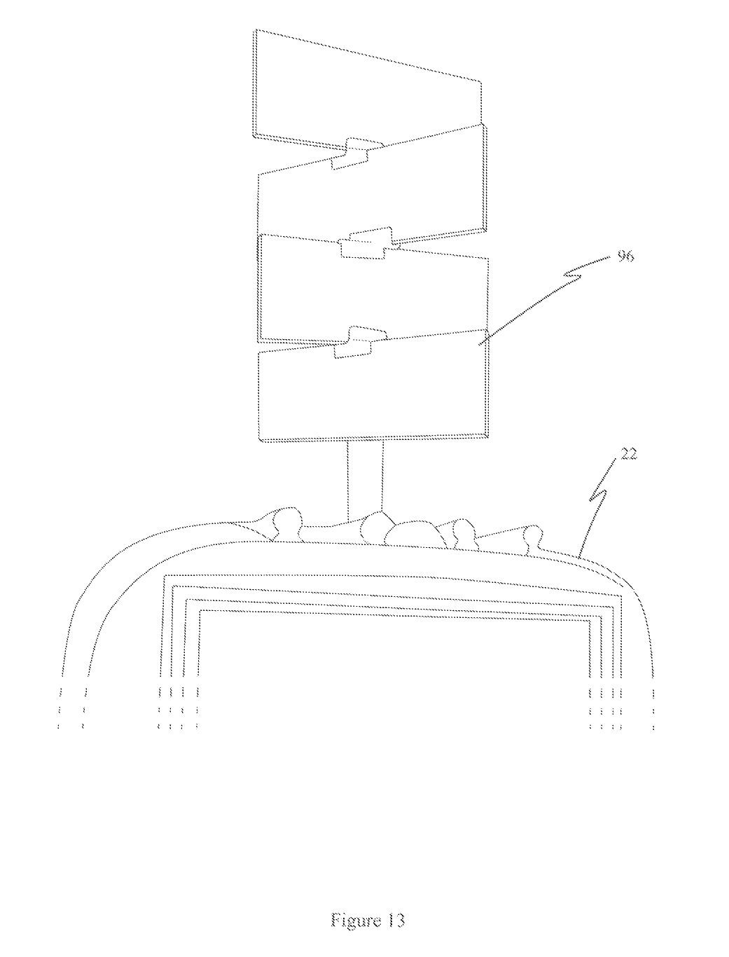

The kiosk 10 according to the present invention can also have street signs 96 mounted on top of the kiosk housing 22 as shown in FIG. 13.

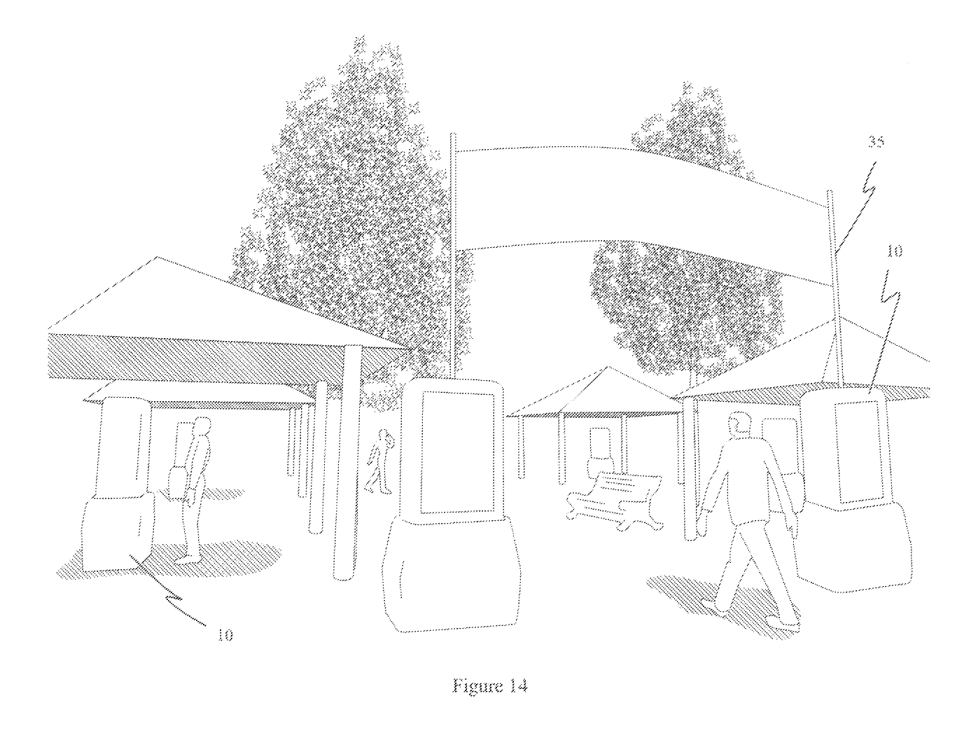

The kiosk 10 according to the present invention can also have a pole 35 for supporting an article, such as a banner or a tent, as shown in FIG. 14.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A kiosk comprising:
a kiosk housing having inner walls, outer walls, and an air circulation path between said inner walls and outer walls, said inner walls defining an interior space; and
a blower for supplying air into said air circulation path so as to fill said air circulation path with pressurized air.

2. The kiosk of claim 1, further comprising:
a mist nozzle unit having a water injection nozzle and an air hole, said air hole disposed adjacent said water injection nozzle;
a water chamber for storing water therein; and
a water pump for pumping water from said water chamber to said water injection nozzle.

3. The kiosk of claim 2, further comprising a water conduit, wherein said water injection nozzle and said air hole are disposed in said kiosk housing, wherein said water conduit is connected between said water pump and said water injection nozzle, and wherein said air hole communicates with said air circulation path such that the pressurized air can exit said air circulation path via said air hole.

4. The kiosk of claim 1, further comprising a light disposed within said interior space.

5. The kiosk of claim 1, further comprising:
a visual display;
a pivot arm having a first end and a second end, one of said first end and said second end being pivotally connected to said visual display, and the other of said first end and said second end being pivotally connected to said kiosk.

6. The kiosk of claim 1, further comprising a side panel removably mounted onto said kiosk housing.

7. The kiosk of claim 6, wherein said side panel comprises a box module having an opening for one of collecting and dispensing articles, and further having an angled divider plate disposed within said box module.

8. The kiosk of claim 1, further comprising a light device, wherein said kiosk housing is translucent and said light device illuminates said kiosk housing.

9. The kiosk of claim 1, further comprising an audio system having a speaker.

10. The kiosk of claim 1, further comprising a scent medium retainer located adjacent to said blower.

11. The kiosk of claim 2, further comprising:
a light device;
an LCD display;
an audio system having a speaker; and
a control board;
wherein said control board has a switch module for allowing a user to selectively turn on and off any of said blower, said water pump, said light device, said LCD display, and said audio system.

12. The kiosk of claim 11, wherein said control board has a connection terminal for receiving an output jack of a video/audio device.

13. The kiosk of claim 12, wherein said control board has a device holder for removably retaining the video/audio device.

14. The kiosk of claim 1, further comprising a tube extending vertically through said kiosk housing, said tube being adapted to receive electric power lines and water lines.

15. The kiosk of claim 2, further comprising:
a tank base;
casters mounted onto said tank base, said tank base having an inner wall defining said water chamber; and
a handle disposed on top of said kiosk.

16. The kiosk of claim 1, further comprising:
a misting unit mounted on said kiosk housing, said misting unit having a water injection nozzle;
a water chamber for storing water therein;
a water pump for pumping water from said water chamber to said water injection nozzle; and
a water conduit connected between said water pump and said water injection nozzle;
wherein said misting unit has an opening, and a fan for blowing out air through said opening, and wherein said water nozzle is disposed within said opening.

17. The kiosk of claim 1, further comprising a heater device mounted on said kiosk housing.

18. The kiosk of claim 1, further comprising a camera device attached to said kiosk housing.

19. The kiosk of claim 1, further comprising a pole mounted on said kiosk housing for supporting an article.
